(19) United States
(12) Patent Application Publication
(10) Pub. No.: US 2026/0245508 A1
(43) Pub. Date: Aug. 20, 2026

(54) METHOD AND DEVICE FOR IMAGE STICKING COMPENSATION IN ORGANIC LIGHT-EMITTING DIODE DISPLAY

(71) Applicant: Novatek Microelectronics Corp., Hsinchu (TW)

(72) Inventors: Shang-Yu Su, Hsinchu County (TW); Xuan-Yong Lin, Hsinchu City (TW); Feng-Ting Pai, Hsinchu City (TW)

(73) Assignee: Novatek Microelectronics Corp., Hsinchu (TW)

(21) Appl. No.: 19/246,607

(22) Filed: Jun. 23, 2025

Related U.S. Application Data
(60) Provisional application No. 63/760,647, filed on Feb. 20, 2025.

(51) Int. Cl. G09G 3/3208

(52) U.S. Cl. CPC G09G 3/3208; G09G 2320/0257; G09G 2320/045

(57) ABSTRACT

A method and a device for image sticking compensation in an organic light-emitting diode (OLED) display are proposed. The method includes to receive a current frame, compute current offset data corresponding to the current frame based on previous cumulative stress data indicating accumulated stress imposed on the OLED display by one or more previous frames preceding the current frame, and apply the current offset data to the current frame to generate a compensated current frame, where the current offset data includes a first current offset value that is positive and a second current offset value that is negative.

### CROSS-REFERENCE TO RELATED APPLICATION

This application claims the priority benefit of U.S. provisional application serial no. 63/760,647, filed on February 20, 2025. The entirety of the above-mentioned patent application is hereby incorporated by reference herein and made a part of this specification.

### TECHNICAL FIELD

The disclosure relates to a method and a device for image sticking compensation in an organic light-emitting diode (OLED) display.

### BACKGROUND

OLED panels are widely used in modern displays due to their advantages in high contrast ratio, rich color, and structural flexibility. However, one major drawback inherent to OLED technology is image sticking, also known as residual image or ghost image, which occurs when static images are displayed for a prolonged period. This phenomenon is primarily caused by charge trapping and differential aging in the OLED emission layer, occasionally exacerbated by hysteresis in the driving thin-film transistors (TFTs), resulting in brightness inconsistencies when switching between grayscale levels.

For example, when a static image such as a checkerboard pattern with a grayscale level GL0 or GL255 is displayed continuously, the first several frames after switching to a new image may exhibit visible brightness variation. Specifically, pixels previously displaying GL0 may appear brighter than expected, while those displaying GL255 may appear darker. Over time, these anomalies gradually fade and the brightness stabilizes, yet the transient brightness inconsistency still adversely affects image quality.

Conventional solutions attempt to mitigate image sticking by modifying material characteristics or circuit architectures. One approach involves altering the voltage levels at the gate, drain, and source of the TFT and also at the OLED anode and cathode to ensure charge neutrality before initiating the compensation and emission phases. However, these solutions often require transitioning from a 7T1C to an 8T1C circuit configuration, which introduces additional timing complexity, reduces production yield, and increases manufacturing cost. Moreover, existing approaches typically do not account for different display conditions such as display brightness value (DBV), ambient temperature, frame rate, or image load. These factors also affect pixel behavior and may lead to further brightness instability.

Accordingly, there remains a need for an improved compensation scheme that can accurately detect and address image sticking issues without requiring changes to existing OLED panel circuits or driving schemes.

### SUMMARY OF THE DISCLOSURE

To solve the prominent issue, a method and a device for image sticking compensation in an OLED display are proposed.

According to one of the exemplary embodiments, the method includes to receive a current frame, compute current offset data corresponding to the current frame based on previous cumulative stress data indicating accumulated stress imposed on the OLED display by one or more previous frames preceding the current frame, and apply the current offset data to the current frame to generate a compensated current frame, where the current offset data includes a first current offset value that is positive and a second current offset value that is negative.

According to one of the exemplary embodiments, the device includes at least one memory and a processing circuit. The processing circuit is configured to receive a current frame, compute current offset data corresponding to the current frame based on previous cumulative stress data indicating accumulated stress imposed on the OLED display by one or more previous frames preceding the current frame, and apply the current offset data to the current frame to generate a compensated current frame, where the current offset data includes a first current offset value that is positive and a second current offset value that is negative.

It should be understood, however, that this summary may not contain all of the aspects and embodiments of the disclosure and is therefore not meant to be limiting or restrictive in any manner. Also, the disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a schematic diagram of a device for image sticking compensation in an OLED display in accordance with an exemplary embodiment of the disclosure.

FIG. 2 illustrates a flowchart of a method for image sticking compensation in an OLED display in accordance with another exemplary embodiment of the disclosure.

FIG. 3 illustrates a flowchart of a method for image sticking compensation in an OLED display in accordance with another exemplary embodiment of the disclosure.

FIG. 4 illustrates a mapping of pixel values to stress values in each stage in accordance with another exemplary embodiment of the disclosure.

FIG. 5 illustrates a signal processing flow of a method for image sticking compensation in an OLED display in accordance with an exemplary embodiment of the disclosure.

FIG. 6A and FIG. 6B illustrate a first scenario of a method for image sticking compensation in an OLED display in accordance with an exemplary embodiment of the disclosure.

FIG. 7A and FIG. 7B illustrate a second scenario of a method for image sticking compensation in an OLED display in accordance with an exemplary embodiment of the disclosure.

FIG. 8A and FIG. 8B illustrate a third scenario of a method for image sticking compensation in an OLED display in accordance with an exemplary embodiment of the disclosure.

To make the above features and advantages of the disclosure more comprehensible, several embodiments accompanied with drawings are described in detail as follows.

### DESCRIPTION OF THE EMBODIMENTS

Some embodiments of the disclosure will now be described more fully hereinafter with reference to the accompanying drawings, in which some, but not all embodiments of the disclosure are shown. Indeed, various embodiments of the disclosure may be embodied in various forms and should not be construed as limited to the embodiments set forth herein; rather, these embodiments are provided so that this disclosure will satisfy applicable legal requirements. Like reference numerals refer to like elements throughout.

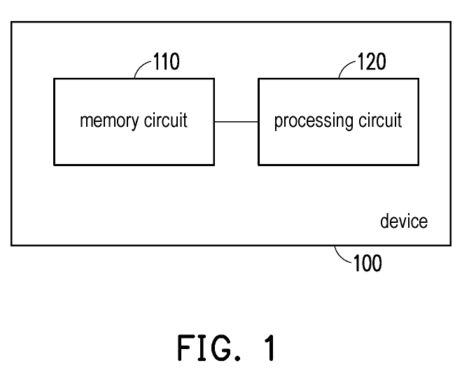

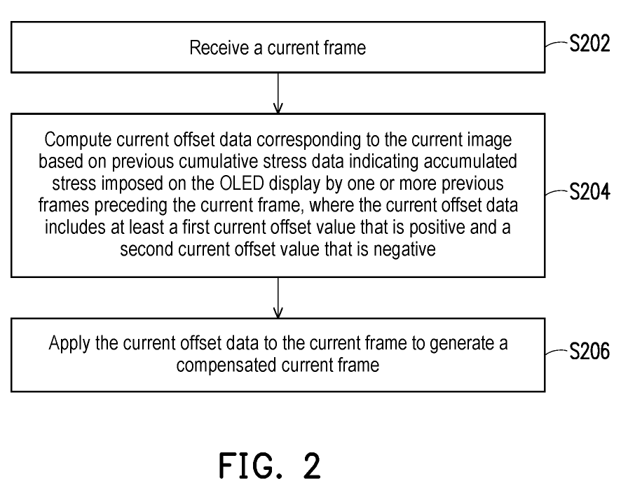

FIG. 1 illustrates a schematic diagram of a device for image sticking compensation in an OLED display in accordance with an exemplary embodiment of the disclosure. All components and configurations of the device are first introduced in FIG. 1, and their functionalities are further described in conjunction with FIG. 2.

Referring to FIG. 1, a device 100 includes at least one memory circuit 110 and at least one processing circuit 120. In one implementation, the device 100 may be configured as a control unit coupled to or integrated within an OLED display. The OLED display may include an OLED panel configured to emit light based on pixel data as well as additional driving circuits, control logic, and power modules. The device 100 may be implemented as part of a timing controller (TCON), a display driver IC (DDIC), or a standalone image processing unit. The device 100 is configured to provide compensated image signals to the OLED display for visual output. The compensated frame generated by the processing circuit 120 may be transmitted to a data driver or source driver of the OLED display to control pixel emission on the OLED panel. In some embodiments, the device 100 may be integrated within the same substrate or package as the OLED display. In other embodiments, the device 100 may be implemented as a discrete module connected via a communication interface.

The memory circuit 110 is configured to store data related to image processing. In some embodiments, different types of data may be stored in different memory circuits or different memory blocks. The processing circuit 120 is operatively coupled to the memory circuit 110 and configured to perform computations based on the stored data. The processing circuit 120 may include one or more submodules, which may be implemented in hardware such as digital logic, analog circuitry, or combinations thereof. The configurations of the memory circuit 110 and the processing circuit 120 may vary depending on application-specific requirements or hardware constraints, and may be integrated into a single integrated circuit (IC) or distributed across multiple chips.

FIG. 2 illustrates a flowchart of a method for image sticking compensation in an OLED display in accordance with an exemplary embodiment of the disclosure, where the steps of FIG. 2 may be performed by the device 100 as illustrated in FIG. 1.

Referring to FIG. 2 in conjunction with FIG. 1, the processing circuit 120 of the device 100 receives a current frame (Step S202). The current frame may represent a frame to be displayed on the OLED display, and may be received from a host processor, a frame buffer, or an image processing pipeline. In the present embodiment, the current frame may be part of a time series of frames, such as those in a video stream or a sequence of static images, and may be processed in real time as part of a continuous display operation.

Next, the processing circuit 120 computes current offset data corresponding to the current image based on previous cumulative stress data indicating accumulated stress imposed on the OLED display by one or more previous frames preceding the current frame, where the current offset data includes at least a first current offset value that is positive and a second current offset value that is negative (Step S204). The previous cumulative stress data may characterize the degree of stress experienced by specific regions or pixels of the OLED display due to repeated or prolonged exposure to high luminance levels. Based on the previous cumulative stress data, the processing circuit 120 computes the current offset data to correct brightness deviations in the current frame. The positive offset value may be applied to enhance brightness in pixels exhibiting luminance deficiency, whereas a negative offset may be applied to reduce brightness in pixels exhibiting luminance excess. In some cases, an offset value may be set to zero, indicating that no compensation is required for a given region or a pixel.

The processing circuit 120 applies the current offset data to the current frame to generate a compensated current frame (Step S206). The compensated current frame may be transmitted to a source driver or data driver for output on the OLED display, thereby improving visual consistency and mitigating image sticking artifacts.

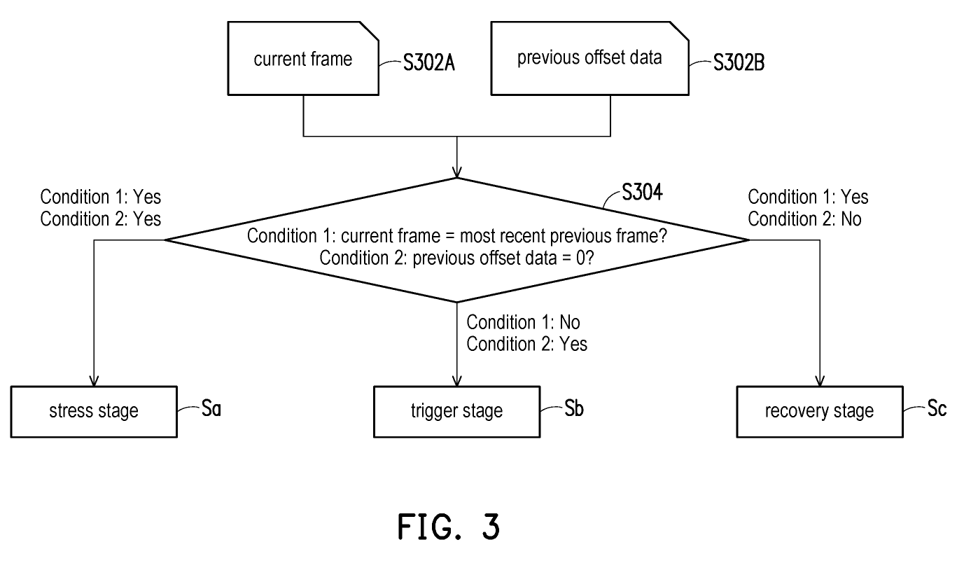

However, image sticking does not typically arise when image content changes constantly across frames. Accordingly, a mechanism may be employed to dynamically determine whether image compensation should be performed on a frame-by-frame basis. To be specific, FIG. 3 illustrates a flowchart of a method for image sticking compensation in an OLED display in accordance with another exemplary embodiment of the disclosure, where the steps of FIG. 3 may be performed by the device 100 as illustrated in FIG. 1.

Referring to FIG. 3 in conjunction with FIG. 1, the processing circuit 120 receives a current frame (Step S302A) and retrieves previous offset data corresponding to a most recent previous frame among a series of previous frames (Step S302B). The processing circuit 120 then determines whether image content of the current frame is identical to image content of the most recent previous frame (i.e. Condition 1) and determines whether the previous offset data is zero (i.e. Condition 2) (Step S304). It should be noted that the sequence in which these two conditions are evaluated may be interchanged without affecting the resultant logical determination.

When both conditions are satisfied (i.e. the image content remains unchanged and the previous offset data equals zero), the processing circuit 120 determines that the current frame is in a stress stage Sa and accordingly initiates the relevant process.

In the stress stage Sa, the processing circuit 120 sets the current offset data of the current frame to zero, indicating that no immediate compensation is required. At the same time, the processing circuit 120 computes current stress data based on a pixel-to-stress lookup table that maps pixel values to corresponding stress values.

To account for dynamic display environments, the current stress data may be further scaled using a stress scaling factor derived from one or more external parameters affecting luminance output of the OLED display, such as DBV, temperature, frame rate, and image loading. That is, the current stress data may be computed based on the current pixel values of the current frame, the pixel-to-stress lookup table, and the stress scaling factor in the stress stage. This scaling enables the compensation mechanism to reflect real-time operating conditions, thereby enhancing the accuracy and responsiveness of stress modelling. Thereafter, the processing circuit 120 accumulates current stress data and the previous cumulative stress data to generate updated cumulative stress data, which may be stored in a dedicated memory for use in subsequent stage determinations and offset computations.

When the image content of the current frame differs from that of the most recent previous frame while the previous offset data is zero, the processing circuit 120 determines that the current frame is in a trigger stage Sb and accordingly initiates the relevant process.

In the trigger stage Sb, a change in image content following a prolonged period of stress accumulation is interpreted as a signal indicating the potential onset of image sticking. Accordingly, the processing circuit 120 sets the current stress data to zero for the current frame, and initiates computation of current offset data based on the previous cumulative stress data and a stress-to-offset lookup table that maps stress values to offset values.

To account for dynamic display environments, the current offset data may be further scaled using an offset scaling factor derived from one or more external parameters affecting luminance output of the OLED display as well. That is, the current offset data may be computed based on a difference between the previous cumulative stress data and initial stress data, the stress-to-offset lookup table, and the offset scaling factor.

When the image content of the current frame is identical to that of the most recent previous frame and the previous offset data is non-zero, the processing circuit 120 determines that the current frame is in a recovery stage Sc and accordingly initiates the relevant process.

In the recovery stage Sc, the processing circuit 120 computes the current stress data based on current pixel values and a recovery pixel-to-stress lookup table that maps pixel values to stress values having signs opposite to those of the pixel-to-stress lookup table used in the stress stage Sa. Similarly, the current stress data may be computed based on the current pixel values, the recovery stress lookup table, and the stress scaling factor. The processing circuit 120 also computes the current offset data based on the previous cumulative stress data and a recovery stress-to-offset lookup table that maps stress values to offset values. Similarly, the current offset data may be computed based on a difference between the previous cumulative stress data and initial stress data, the recovery stress-to-offset lookup table, and the offset scaling factor.

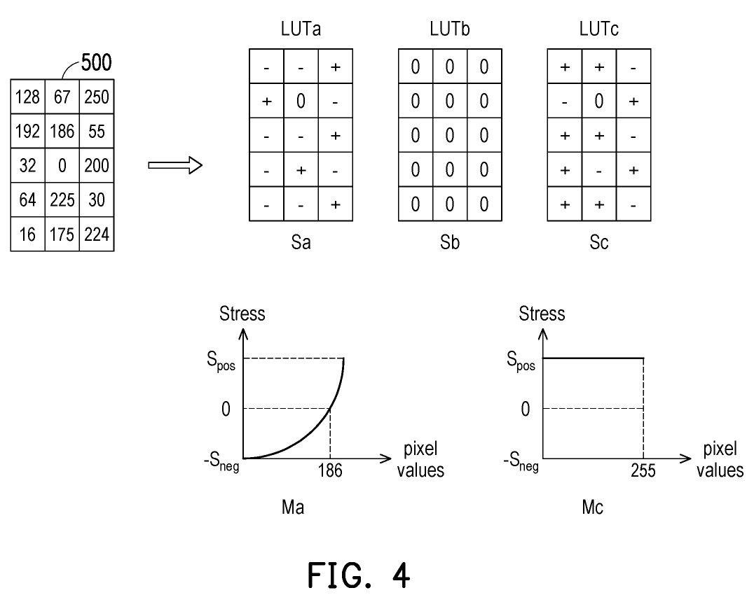

The data structures and control logic described above across the stress, trigger, and recovery stages are collectively illustrated in FIG. 4, which depicts a mapping of pixel values to stress values in each stage in accordance with another exemplary embodiment of the disclosure.

In one exemplary embodiment, each pixel or subpixel is assigned a 9-bit memory location to store cumulative stress data, enabling a numerical range from 0 to 511. The mechanism employs three distinct pixel-to-stress lookup tables, each selected according to the current stage. In the stress stage Sa, a lookup table LUTa maps pixel values to stress values. The LUTa may adopt a non-linear curve Ma, such as a gamma-based or exponential profile, where higher grayscale input results in disproportionately larger stress values, reflecting accelerated degradation in brighter areas of the display. In the trigger stage Sb, a lookup table LUTb maps all pixel values to zero stress values, thereby suspending additional stress accumulation. In the recovery stage Sc, a lookup table LUTc maps pixel values to stress values having signs opposite to those of the lookup table LUTa, using a curve that may be either identical to the aforementioned curve Ma, a differently designated curve, or a constant function Mc. These lookup tables enable the system to apply differentiated stress modeling behavior tailored to each stage.

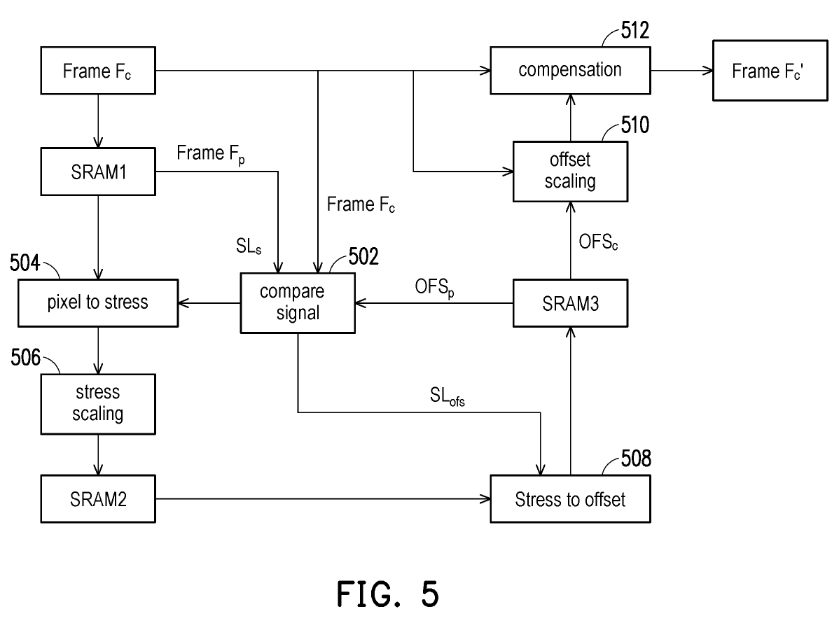

FIG. 5 illustrates a signal processing flow of a method for image sticking compensation in an OLED display in accordance with an exemplary embodiment of the disclosure. Note that details of the processes are omitted herein but have been described in previous sections.

Referring to FIG. 5, the memory circuit 110 in FIG. 1 is implemented as three distinct memory units, namely SRAM1, SRAM2, and SRAM3, to store image data, accumulated stress data, and offset data, respectively. The processing circuit 120 in FIG. 1 is implemented using various functional units configured to perform associated operations as follows.

A current frame Fc is received and stored in SRAM1, which also stores a previous frame Fₚ. A compare signal unit 502 compares the current frame F_{c} with the previous frame Fₚ and determines whether previous offset data OFSₚ retrieved from SRAM3 is zero to generate a signal SLₛ and a signal SL_{ofs}. The current frame F_{c} is processed by a pixel-to-stress mapping unit 504 and a stress scaling unit 506 according to the signal SLₛ, and the resulting current stress data is then stored in SRAM2. A stress-to-offset mapping unit 508 retrieves previous cumulative stress data from SRAM2 according to the signal SL_{ofs} to generate current offset data OFS_{c}, which is stored in SRAM3 for later use. The current offset data OFS_{c} is also processed by an offset scaling unit 510. The scaled offset data is subsequently applied to the current frame Fc by a compensation unit 512 to generate a compensated current frame Fc′, which may be further processed or output for display rendering.

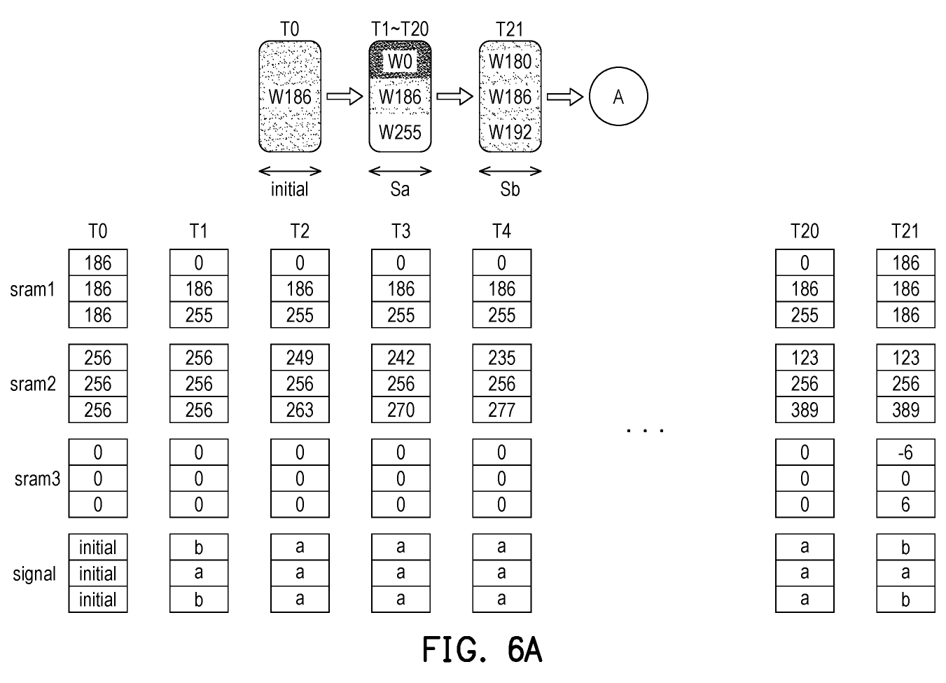

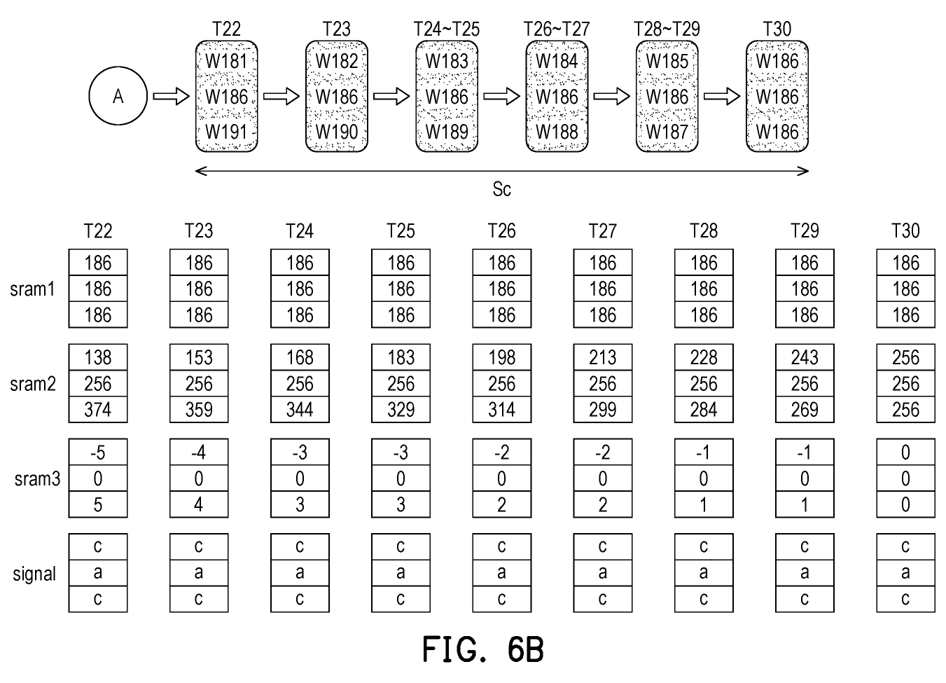

FIG. 6A and FIG. 6B illustrate a first scenario of a method for image sticking compensation in an OLED display in accordance with an exemplary embodiment of the disclosure, where the stress, trigger, and recovery stages are alternated in a dynamic sequence driven by multiple image transitions and static intervals.

Referring to FIG. 6A, at time T0, an initial frame with uniform pixel values (W186) is received and held as a baseline. Beginning at time T1, a new frame is presented with varying pixel values (W0, W186, W255), which persists until time T20. The interval from time T1 to time T20 is identified as the stress stage Sa, during which stress accumulation takes place. The pixel values are repeatedly written into SRAM1 and converted into stress values via pixel-to-stress mapping and stress scaling, and the resulting stress data is stored in SRAM2.

At time T21, a change in pixel values is detected as the current frame transitions to a new set of uniform pixel values (W186), and this transition is considered as an entry into the trigger stage Sb. During this stage, the cumulative stress values stored in SRAM2 are no longer updated. Instead, the previously accumulated stress values are processed via stress-to-offset mapping, and the resulting offset values are written into SRAM3. It should be noted that, a stage-identifying signal may be issued on a region-by-region basis within each frame to facilitate localized compensation. Specifically, “a” denotes the stress stage, “b” denotes the trigger stage, and “c” denotes the recovery stage. This stage information is determined based on frame comparison results and previous offset data and governs operations such as lookup table selection and sign determination.

Referring to FIG. 6B, at time T22, the pixel values remain stable (W186), marking the beginning of the recovery stage Sc. During this stage, the cumulative stress values stored in SRAM2 are read, and current stress data with signs opposite to those used in the stress stage Sb is generated. Such reverse stress contributions are added to the previously accumulated stress, and the resulting current stress is used to generate offset values. The magnitudes of the offset values in SRAM3 gradually decrease over time, and by time T30, all entries return to zero, indicating that the compensation effect has been completed.

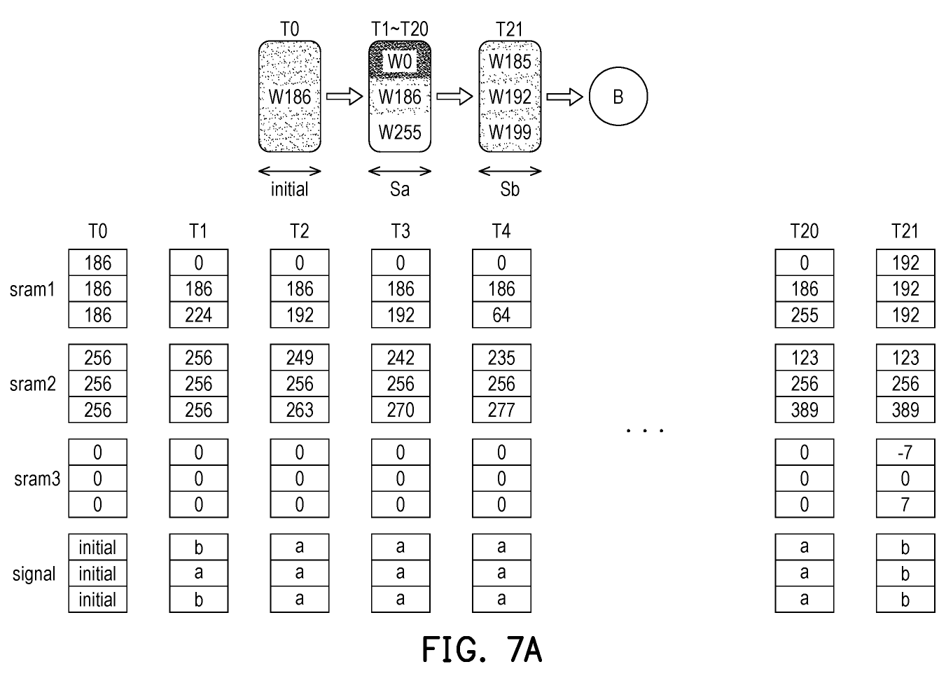

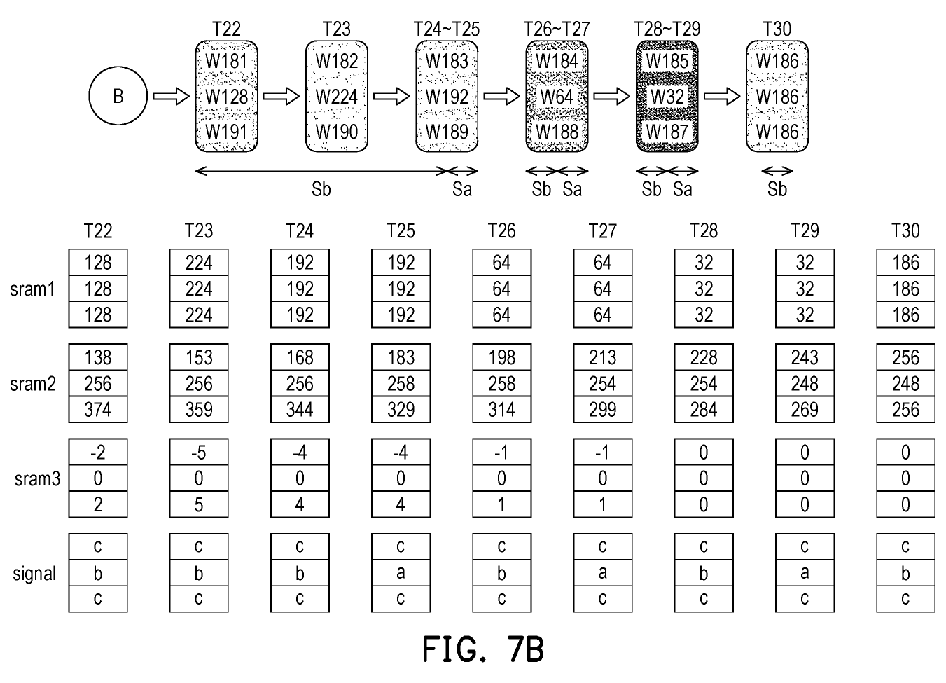

FIG. 7A and FIG. 7B illustrate a second scenario of the image sticking compensation method in accordance with an exemplary embodiment of the disclosure. In this scenario, the process undergoes multiple transitions across stress, trigger, and recovery stages in response to dynamic changes in image content. While the figures provide detailed memory behaviour and pixel-level variations, the explanation is omitted herein, as those skilled in the art may readily infer such information from the context above.

Referring to FIG. 7A and FIG. 7B, from time T1 to time T20, pixel values remain unchanged, leading to continuous stress accumulation. The resulting stress values are stored in SRAM2, while the offset values in SRAM3 remain at zero during this interval. At time T21, a noticeable shift in pixel values is detected, signaling the start of the trigger stage Sb. In response, updated offset values are computed based on the new pixel conditions and stored in SRAM3. From time T22 to time T24, pixel values continuously change across frames. As the displayed image does not stabilize, the process remains in the trigger stage Sb throughout this interval. From time T26 to time T30, the process alternates between the stress stage Sa and the trigger stage Sb.

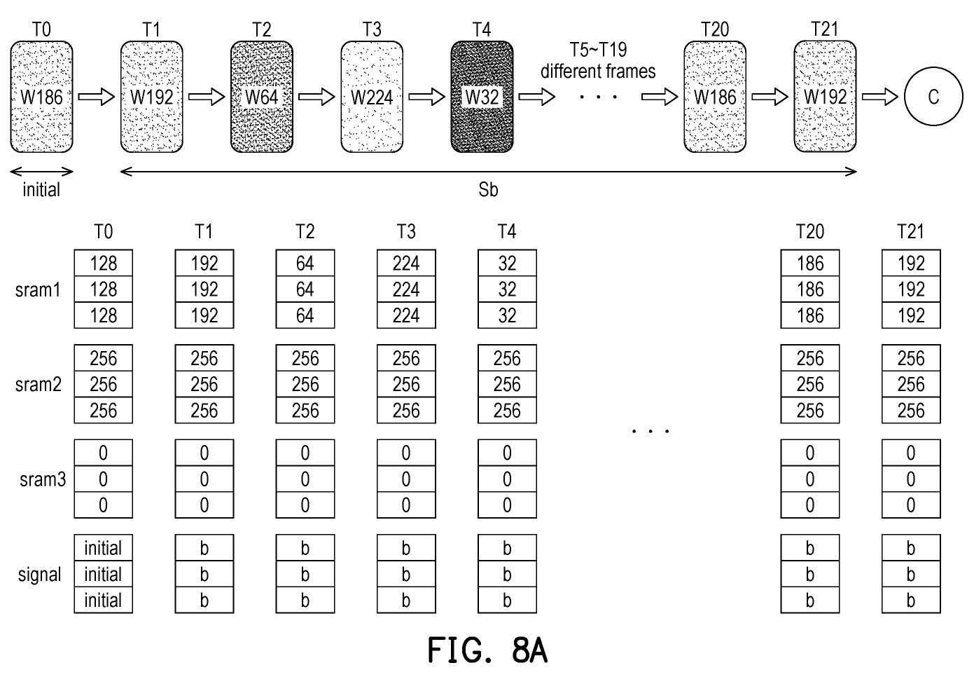

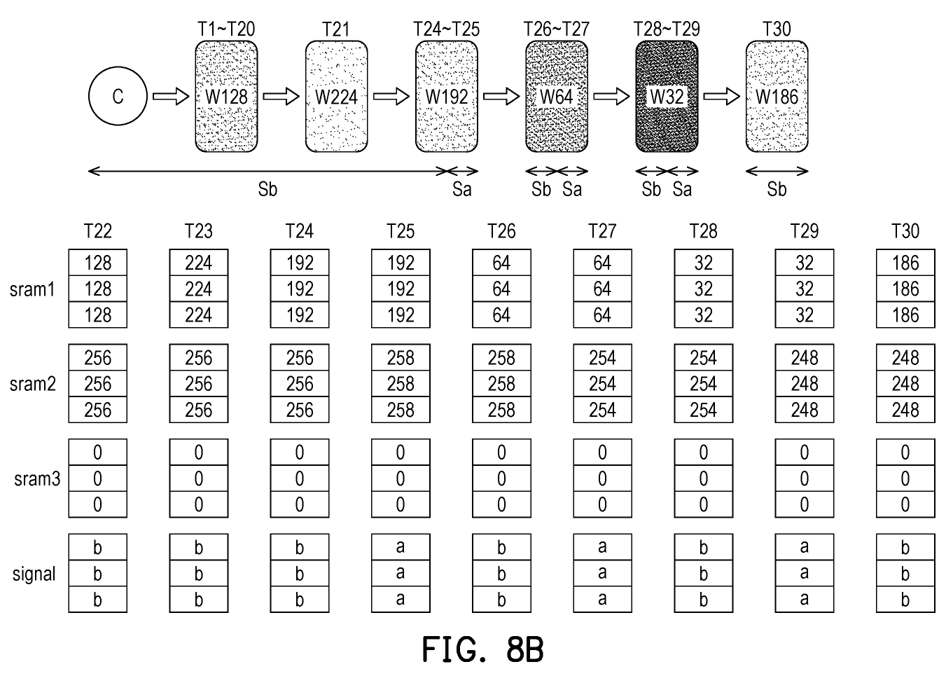

FIG. 8A and FIG. 8B illustrate a third scenario of a method for image sticking compensation in an OLED display in accordance with an exemplary embodiment of the disclosure. In this scenario, the process does not enter the recovery stage Sc. While the figures provide detailed memory behaviour and pixel-level variations, the explanation is omitted herein, as those skilled in the art may readily infer such information from the context above.

Referring to FIG. 8A and FIG. 8B, the image content changes frequently during time T1 to T24, resulting in no updates in the stress values stored in SRAM2. The offset values in SRAM3 remain zero throughout this period, indicating that compensation mechanism is not applied. At time T25, a new pixel shift reactivates the trigger stage Sa, followed by another transition into the trigger stage Sb. The stress values are updated accordingly without additional offset adjustments.

In summary, the proposed scheme employs a stage-based control mechanism to continuously monitor pixel usage and apply dynamic offset values, thereby providing a robust and scalable framework for extending OLED panel lifespan while preserving high image fidelity.

No element, act, or instruction used in the detailed description of disclosed embodiments of the present application should be construed as absolutely critical or essential to the present disclosure unless explicitly described as such. Also, as used herein, each of the indefinite articles "a” and “an” could include more than one item. If only one item is intended, the terms "a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method for image sticking compensation in an organic light-emitting diode (OLED) display comprising:
receiving a current frame;
computing current offset data corresponding to the current frame based on previous cumulative stress data indicating accumulated stress imposed on the OLED display by one or more previous frames preceding the current frame, wherein the current offset data comprises a first current offset value that is positive and a second current offset value that is negative; and
applying the current offset data to the current frame to generate a compensated current frame.

2. The method according to claim 1 further comprising:
obtaining previous offset data corresponding to a most recent previous frame among the one or more previous frames;
determining whether image content of the current frame is identical to image content of the most recent previous frame and determining whether the previous offset data is zero; and
in response to the image content of the current frame being identical to the image content of the most recent previous frame and the previous offset data being zero, determining that the current frame is in a stress stage.

3. The method according to claim 2 further comprising:
setting the current offset data corresponding to the current frame to zero in the stress stage.

4. The method according to claim 2 further comprising:
accumulating current stress data and the previous cumulative stress data to generate current cumulative stress data in the stress stage.

5. The method according to claim 4,
wherein the current stress data is computed based on current pixel values of the current frame and a pixel-to-stress lookup table in the stress stage, wherein the pixel-to-stress lookup table maps pixel values to stress values.

6. The method according to claim 5,
wherein the current stress data is computed based on the current pixel values of the current frame, the pixel-to-stress lookup table, and a stress scaling factor associated with one or more external parameters affecting luminance output of the OLED display in the stress stage.

7. The method according to claim 1 further comprising:
obtaining previous offset data corresponding to a most recent previous frame among the one or more previous frames;
determining whether image content of the current frame is identical to image content of the most recent previous frame and determining whether the previous offset data is zero; and
in response to the image content of the current frame not being identical to the image content of the most recent previous frame and the previous offset data being zero, determining that the current frame is in a trigger stage.

8. The method according to claim 7 further comprising:
setting current stress data to zero in the trigger stage.

9. The method according to claim 7,
wherein the current offset data is computed based on the previous cumulative stress data and a stress-to-offset lookup table in the trigger stage, wherein the stress-to-offset lookup table maps stress values to offset values.

10. The method according to claim 9,
wherein the current offset data in the trigger stage is computed based on a difference between the previous cumulative stress data and initial stress data, the stress-to-offset lookup table, and an offset scaling factor associated with one or more external parameters affecting luminance output of the OLED display in the trigger stage.

11. The method according to claim 1 further comprising:
obtaining previous offset data corresponding to a most recent previous frame among the one or more previous frames;
determining whether image content of the current frame is identical to image content of the most recent previous frame and determining whether the previous offset data is zero; and
in response to the image content of the current frame being identical to the image content of the most recent previous frame and the previous offset data not being zero, determining that the current frame is in a recovery stage.

12. The method according to claim 11,
wherein the current stress data is computed based on current pixel values of the current frame and a recovery pixel-to-stress lookup table in the recovery stage,
wherein the recovery pixel-to-stress maps pixel values to stress values having signs opposite to signs of a pixel-to-stress lookup table used in a stress stage.

13. The method according to claim 12,
wherein the current stress data is computed based on the current pixel values of the current frame, the recovery stress lookup table, and a stress scaling factor associated with one or more external parameters affecting luminance output of the OLED display in the recovery stage.

14. The method according to claim 11,
wherein the current offset data is computed based on the previous cumulative stress data and a recovery stress-to-offset lookup table in the recovery stage,
wherein the recovery stress-to-offset lookup table maps stress values to offset values.

15. The method according to claim 14,
wherein the current offset data is computed based on a difference between the previous cumulative stress data and initial stress data, the recovery stress-to-offset lookup table, and an offset scaling factor associated with one or more external parameters affecting luminance output of the OLED display in the recovery stage.

16. A device for image sticking compensation in an organic light-emitting diode (OLED) display comprising:
at least one memory circuit;
at least one processing circuit, configured to:
receive current frame;
compute current offset data corresponding to the current frame based on previous cumulative stress data indicating accumulated stress imposed on the OLED display by one or more previous frames preceding the current frame, wherein the current offset data comprises a first current offset value that is positive and a second current offset value that is negative; and
apply the current offset data to the current frame to generate a compensated current frame.
